(19) United States
(12) Patent Application Publication
(10) Pub. No.: US 2010/0099943 A1
(43) Pub. Date: Apr. 22, 2010

(54) MUSIC ENHANCED MASSAGE SYSTEM

(76) Inventor: Sean DAVIS, Wilmington, DE (US)

Correspondence Address: CONNOLLY BOVE LODGE & HUTZ, LLP, P O BOX 2207, WILMINGTON, DE, 19899, US

(21) Appl. No.: 12/565,086

(22) Filed: Sep. 23, 2009

Related U.S. Application Data
(60) Provisional application No. 61/107,461, filed on Oct. 22, 2008.

(51) Int. Cl. A61H 99/00

(52) U.S. Cl. 600/28

(57) ABSTRACT

A music enhanced massage system includes a first set of headphones that would be worn by the recipient to be massaged. A second set of headphones is worn by the massage practitioner. Music is simultaneously transmitted to both sets of headphones so that the massage practitioner can massage the recipient in accordance with the sound of the music.

### CROSS-REFERENCE TO RELATED APPLICATION

This application is based on provisional application Ser. No. 61/107,461, filed Oct. 22, 2008, all of the details of which are incorporated herein by reference thereto.

### BACKGROUND OF THE INVENTION

Various types of massage techniques have been known, these include variations of Swedish massage, Acupressure, Trigger Point Therapy, Deep Tissue massage and Amma. It is also known to use music as part of the environment in the massage room. The use of such music, however, is primarily intended to relax the recipient. No efforts are made to find any correlation between the music and the actual massage techniques.

### SUMMARY OF THE INVENTION

An object of this invention is to provide a system that integrates the massage techniques with the selection of music.

In accordance with this invention a system is provided wherein various components are used in a series of steps to improve the quality of the massage. This provides better results for the recipient's mental and physical well being. Such steps involve integrating music and sound, ambient noise reduction, 360 degree site cancellation, aroma therapy, massage and the use of a grid of the human body and its extremities.

### THE DRAWINGS

FIGS. 1-14 illustrate various massage techniques and body grid correlated to the selection of user.

### DETAILED DESCRIPTION

The system involves a process of massage that utilizes several components in a series of steps to improve the quality of the massage providing better results for the recipient's mental and physical well being. It involves integrating music and sound, ambient noise reduction, 360 degree sight cancellation, aromatherapy, massage, and a newly designed grid of the human body and its extremities. This grid matches the three basic tonal levels of a music scale, high, medium and low notes. The massage practitioner uses this grid to flow with music and sound during the massage by way of varying pressure, stroke value, stroke speed and movements. There are specific massage strokes with pressure variances and movements coinciding with rhythm and tempo patterns and changes in scale progression, breakdowns, sustained notes, chords and sporadic sounds to further enhance the massage experience. Along with the specific massage strokes, the template modalities used for this system are all the strokes and variations of Swedish massage, Acupressure, Trigger Point Therapy, Deep Tissue massage and Amma. The most rewarding aspect from a massage practitioner's point of view is that once the system is understood they can integrate it into their preferred style and just follow the grid with a selection of music and implementing the other components within this system.

The following are some considerations relating to the system of this invention.

360 degree sight cancellation relaxes the motor cortex and triggers the body into a state of homeostasis. The recipient doesn't have to consciously keep their eyes closed.

Ambient noise reduction eliminates sounds that aren't related to massage, enabling the recipient to keep a clear mind.

Aromatherapy helps to cope with mental and physical conflicts like allergies, stress and anxiety.

Applying music and sound through noise reduction headphones stimulates neuropathic activity. Heart rhythms match to brain synapse output. Applying music to massage, it stimulates or sedates the central nervous systems.

Using the grid, the practitioner moves with music along the body. Notes ascending the scale, strokes are proximal. Notes descending the scale, strokes are distal. More pressure and slower stroke speed is applied with stronger tone intensity. Less pressure and faster stroke speed is applied with higher tone intensity.

The system mentally, psychologically and physiologically removes the massage recipient from their immediate environment. It assists in overall relaxation enhancing all of those factors and the massage experience in a way that has never been approached before. By combining the components mentioned in the description, it accomplishes several positive results at once for the massage recipient.

Being that it is a process of massage, it can be implemented into numerous environments using different types of massage applications such as; full body table massage in clinical and physical therapy environments. Holistic healing in spas and retreats, and chair massage used in noisy environments such as airports, public malls, sporting events, or benefit fund raisers. It can also be used in corporations for corporate chair massage. In addition, it can be integrated into “4 hands” full body massage where two massage practitioners massage one body/recipient.

### 360 Degree Sight Cancellation

Implementing 360 degree sight cancellation relaxes the recipients' motor cortex and triggers their mind to reset the body back into a natural state of homeostasis. The massage recipient does not have to consciously keep their eyes closed enabling them to relax into a deeper state, heightening their subconscious mind. It also promotes cell and tissue repair along with cell reproduction. There are a host of other benefits as well.

### Ambient Noise Reduction

This is achieved by fitting the recipient with hard wired, over the ear or in the ear, ambient noise reduction headphones that are connected to one female end of a “Y” splitter headphones jack, while the male end of the “Y” splitter is connected to a female adapter headphones jack of a music playing device. The loose, hanging wire from the recipient's headphones are either taped down to the floor or placed under a throw rug from the music device to the massage table/chair. This ensures a high level of safety for the massage practitioner when moving along the floor. The massage practitioner (CMT/LMT) uses wireless, remote headphones connected to the other open female adapter of the “Y” splitter headphones jack enabling them to move freely around the massage table or massage chair. Appropriate massage music/sounds is played through both sets of headphones at a comfortable level so communication is attainable if need be. Communication between the practitioner and the recipient pertaining to the massage such as inquiring about pressure, being comfortable, when to move, or an emergency of some sort.

Implementing ambient noise reduction eliminates sounds that are not related to the massage that could otherwise jeopardize the quality of the massage itself and the outcome originally intended, which is to help heal and relax the recipient through massage. By doing so, it enables the recipient to completely relax, keeping the mind clear of distractions.

Implementing music and sound through the ambient noise reduction headphones stimulates the neuropathic energy pulses in the recipient's brain immediately affecting cognitive thought and reasoning, as well as their emotional and physiological state. In addition, the rhythm and tempo patterns of music create a bridge for their heart rhythm to match with their brain synapse output. In addition, implementing music and sound directly into the massage sequence and vice versa, it creates a direct link to the massage recipients' sympathetic, parasympathetic and autonomic nervous systems through stimulation and/or sedation caused by the notes, tones, rhythm and tempo patterns, scale progression and breakdowns, sustained notes and chords as well as sporadic sounds.

### Aromatherapy

Implementing aromatherapy promotes a wealth of positive results helping the massage recipient to cope with daily mental and physical conflicts such as stress, anxiety and other physiological issues that might otherwise hinder their normal state of mind.

### Touch and Massage Using the Grid

Implementing touch and massage to the grid, it enables the massage practitioner to move with music and sound along the body and its extremities. The grid, as shown in the drawings is plotted out in such a way that the basic notes of music and sound are directly applied to the body and its extremities through touch and massage. Notes that ascend the music scale, the strokes and movement of massage travel towards the heart (proximal). Note and tones that descend the music scale the strokes and movement of massage travel away from the heart (distal). Pressure variance solely depends which notes and tone intensity the massage practitioner (CMT/LMT) choose to flow with. Normally, the higher the notes and tones are on the music scale, the softer and more superficial the massaged touch is to the recipient. The lower the notes and tones are on the music scale, medium to deep pressure massage is applied to the recipient.

This does not mean that it has to be followed in this exact way. A higher note may project an intense tone, thus paving the way to provide more pressure and varied stroke speed. On the same token, a low note such as a D may have a very weak tone by being placed in the mid to background range of the recording. If the practitioner chooses to flow with that note, the pressure and stroke speed may be lighter by comparison. It is up to the massage practitioner (CMT/LMT) to choose which notes, tones, rhythms and tempos to flow with to better predict the desired outcome of the massage session.

Implementing massage to the grid, the massage practitioner (CMT/LMT) moves with music along the body and its extremities. Notes ascending the music scale, strokes of massage are proximal. Notes descending the music scale, strokes and movement of massage are distal. Pressure depends on which notes and tones they choose to flow with. The stronger the tone, the more pressure is applied with slower stroke speed. The lighter the note intensity, less pressure is applied with a faster stroke speed.

### Audio Preparations

Prior to having massage recipient enter the room, make sure all audio devices are charged, plugged in, on, and preset to play list selected and volume levels prior to starting (This includes MP3 players, portable CD player, laptop, wireless headphone receiver). Make sure wireless headset has fresh batteries and always carry spares.
Set up the music device with both the hard wired ambient noise reduction headphones and remote wireless headphones.
Preset volumes on both the recipients and your headset. This ensures that no damage will occur to hearing. ALWAYS check both headset volumes prior to starting.
Sanitize both pairs of headsets using sanitizer wipes. Let dry.
Prior to taping down cord(s), be sure to leave enough line to get from floor to table/chair. This provides enough line left over for some movement.
When laying out the cord(s) from audio output to table or chair, be sure to tape it to the floor. This ensures a high level of safety for both the recipient and the massage practitioner.
This includes any cords leading to an outlet that might be some distance away from your station/environment. It is vital that all walkways to and from the area are kept clear and free of obstacles.
Be sure to use tape that it at least 2 inches wide, adhesive enough to stay put but not enough to damage carpet of leave residual adhesive marks on a hardwood or laminate floor. Gaffers tape would be the best suited for this purpose.
Always be aware of your surroundings when setting up your station/environment. Be sure to set up systematically. Provide enough space so you can move freely with no obstructions.
Provide enough room in your space so the recipient can get on/off the table and in/out of the massage chair with no obstructions.
Connect both audio jacks from headphones to the “Y” splitter then connect “Y’ splitter to headphones jack in the music device.

### Room Preparations

Set up massage table/massage chair.
Sanitize massage table/massage chair with sanitizer wipes and/or with a non-staining sanitizing solution. Wipe clean and dry with a sanitized cloth.
Table must be covered with a fitted sheet of chosen material, a top sheet and a blanket over the top sheet, along with a sanitized headrest cover.
If table is equipped with a table warmer, be sure to have it on well in advance of the massage session and at a comfortable temperature.
Make sure lighting is at a comfortable level and not too bright.

### Recipient Preparations

Depending on the facility or a private practice, follow protocol for introductions and salutations prior to entering massage room,
Bring recipient to the massage room, let them enter first and kindly, quietly ask for them to sit on the massage table.
Ask necessary questions pertaining to any and all contraindications regarding the massage recipient's physical and mental health along with a thorough review of the massage recipient's “Client Intake Form”. Be specific but brief.
Massage practitioner (CMT/LMT) can choose to wash hands for two minutes while reviewing “Client Intake Form”, or just after massage recipient enters room. Either way, hands must be washed in front of client to ensure cleanliness.
Ask client what type of ailments they are having and what they would like to accomplish with this session. This gives you a bearing on what type of aromatherapy oil to use for that session.
Be sure to cover contraindications regarding scent/oil allergies as well. Some clients are extremely sensitive to some scents such as lavender. They may also have allergic reactions to nut scented oils.
After hearing subjective information from client and ruling out contraindications, match appropriate oil for client's desired outcome.
Verify with them by having them smell it. If suitable, set oil aside for next step in the process. If it is not to their liking, select aromatherapy oil comparable to desired outcome.
Fold a sanitized terrycloth hand towel lengthwise and place few drops of client desired type of aromatherapy oil at the center of the fold, on the fold.
Be sure to ask recipient if they wear a hearing aid or if they have difficulty hearing in general. This provides you with the information needed to adjust the recipient's headset volume accordingly.
If adjustments are necessary, make the adjustments then re-sanitize the massage recipient's hard wired headset. Wipe clean and dry with a sanitized cloth.
For recipients that have never received before in either a chair or on a table, follow the guidelines you were taught in school of how to properly get on a massage table or sit into a massage chair safely, then apply the following steps.

### Session Preparations

Wait a few moments and softly knock on the door while slowly entering the room asking if they are ready. If they are not, leave room closing door for another moment, then repeat. If they are ready, enter the room.
Inform client you will leave the room. Prior to leaving instruct them to lie down on the clean, fitted sheet on the massage table supine (recipient lying on their back), underneath the clean cover sheet and a top blanket, centered on the table and in a comfortable position, ready for massage. The edge of the cover sheet and top blanket are at the recipient's clavicle, leaving their head exposed.
If the client starts prone, make proper adjustments with bolsters and headrest after they are on table.
Place the sanitized, hard wired ambient noise reduction headset comfortably on the recipients' head reducing ambient noise.
Then place the sanitized folded terrycloth towel over the recipients' eyes with the center of the fold just at the tip of their nose so they inhale the aromatherapy oil.
Once sanitized terrycloth towel is in place on the recipient, quietly ask them to take a long, slow, deep, relaxing breath in through the nose and out through the mouth three times.
Be sure to suggest to the recipient just before massage begins that they continue to practice a relaxed breathing cycle.
Tuck each of the folded edges of the cloth snug under the recipient head, between their head and the massage table canceling out ambient light.
If providing table massage and the recipient starts prone, be sure to have sight inhibitor already in the headrest and guide their head into the headrest making sure the center of the fold settles just on the bridge of their nose. Place audio headset onto the recipients head. Ask if it is a comfortable fit and making fine adjustments if need be.
The same applies for providing chair massage, make sure the sight inhibitor is already in headrest and guide their head into it making sure it settles just on the bridge of their nose. Ask if it is a comfortable fit. Make fine adjustments if need be. Place audio headset onto the recipients head. Again, asking if it is a comfortable fit and making fine adjustments if need be.
Before the music and massage begin, ask recipient if they are comfortable. Let them know to communicate with you if music is too loud or soft in the headphones. Also ask them to communicate if massage pressure is too soft or hard so you, the practitioner, can make proper adjustments.
Let massage recipient know that the massage is getting ready to begin.
Ask them to take a long, very slow, relaxed deep breath. When they are exhaling, begin the music.
In timing with music, apply lubricant(s) as you massage.
Using the body grid map as a guide, flow with the music as you massage utilizing all of the factors pertaining to how the grid is used during massage (explained earlier).

The system slightly enhances four of the five known human senses to heighten the massage experience. When these enhancements are implemented into massage separately, they can be somewhat effective. When combined, they change the way to approach and administer massage.

This system can be applied to both corporate chair and full body massage. One of the best traits about this system is the assimilation of music with touch. Because the music is intertwined with the massage sequence, one can do more than wake the recipient up with a rejuvenating and revitalizing massage due to a faster tempo and rhythm. Do more than putting the recipient into a sedated and relaxed state by choosing a slower rhythm and tempo. One can help them connect with themselves in ways they might never have experienced before because of the combined techniques used in this system.

The system provides a new and innovative approach to the massage industry. This system is an easy and welcoming fit for the holistic and therapeutic environment. What's more is it has yet to be introduced to the clinical environment, providing for pre and post operative patients as well as individuals living with existing conditions, pre and post chemo patients, etc.

### Sequence Example

Start client supine and begin at neck, upper traps, pectorals, sub occipitals, etc. (This system is designed without any face or scalp work involved.)
Press play
As music begins, be sure to stay in time with the music with everything you do, including how fast you pump the bottle.
Apply lubricant to your hands
Using the body grid map, work the areas mentioned above using your style of massage and incorporating them with the intricate strokes provided to you
After a few minutes, move to right shoulder, deltoid, pectoral's and neck including sub occipitals
Move onto the right arm. If arm is under the sheet, slowly, and in time with the music, fold sheet on a 45 degree angle from Acromion Process across the body to expose arm
The only part left that needs to be exposed is the right wrist and hand. With minimal movement and in time with the music, bring them out
In time with the music, apply lubricant to entire right arm from shoulder to hand
Using the body grid map, massage your way down the right arm and finish with right hand
Lightly take hold of the recipient's right wrist and palm with your left hand
In time with the music, place the recipients right wrist and hand back under sheet
Do not lose physical contact with recipient during this period
In time with the music, move your left hand on the top (posterior) of recipient's right forearm
In time with the music fold back the sheet
As your folding back the sheet, simultaneously slide left hand up recipient's right arm and complete the stroke up into recipient's right sub-occipital ridge
Still massaging, work your way over to the left shoulder, deltoid, pectoral's and neck including sub occipitals. Reapply lubricant if needed, in time with the music
Move onto the left arm. If arm is under the sheet, slowly, and in time with the music, fold sheet on a 45 degree angle from Acromion Process across the body to expose arm
The only part left that needs to be exposed is the left wrist and hand. With minimal movement and in time with the music, bring them out
In time with the music, apply lubricant to entire left arm from shoulder to hand
Using the body grid map, massage your way down the left arm and finish with right hand
Lightly take hold of the recipient's left wrist and palm with your right hand
In time with the music, place the recipients left wrist and hand back under sheet
Do not lose physical contact with recipient during this period
In time with the music, move your right hand on the top (posterior) of recipient's left forearm
In time with the music fold back the sheet
As your folding back the sheet, simultaneously slide your right hand up recipient's left arm and complete the stroke up into recipient's left sub-occipital ridge
In time with the music, move down to the left leg and undrape
In time with the music, apply lubricant to quads, then calves and shins, then feet
Start at the quads and work your way down to the feet, then drape
In time with the music, move to the right leg and undrape
In time with the music, apply lubricant to quads, then calves and shins, then feet
Start at the quads and work your way down to the feet, then drape
   If timed correctly, the anterior side can be finished as a song is ending.
Remove bolster, prepare headrest then at this point you will be ready to slowly remove eye cover and headset
Using both hand just around the temple of the recipient, take hold of the eye cover (terry cloth towel) at the edge closest to you and slowly remove
Whether music is playing or not, keep the SAME SPEED of movement to remove the eye cover and headset
Upon doing that, you will then place then towel into the headrest just enough to cover clients eyes when their face rests in the headrest/cradle
Go to one side of your recipients table and slowly lean into the table with your thighs/quads at shoulder distance to keep the sheet and cover from moving.
Ask the client how they are doing and if the pressure is ok
Lean over while quietly talking to recipient and grab at shoulder width, the cover and sheet on the other side of the table and slowly pull up creating a 45 degree angle with the cover and sheet, better known as, “tenting”.
Make sure the cover and sheet are a “taught” 45 degrees
Kindly ask the recipient slowly turn over and lightly place their head into the headrest
Ask recipient if the angle of the headrest is satisfactory
If needed, make fine adjustments to headrest
Replace bolster
Ask client to take a long, relaxed, deep breath
Upon them exhaling, slowly replace headset
If by chance when it is time to turn over and music is still playing, let it play
If the music/song is close to or at the end of the recording when you removed the headset, stop the music and moved to next song on pause
Replace headset back on recipients head
Ask for them to take another deep breath and as they exhale, turn on the music
All of this must be done within one minute or less
Do not continue to talk to them . . . be short and sweet
Move onto right posterior leg
In time with the music, apply lubricant to Hams, then if needed, reapply to calves and feet
Massage starting from the Hams down to the feet, re-drape
Move onto right posterior leg
In time with the music, apply lubricant to Hams, then if needed, reapply to calves and feet
Massage starting from the Hams down to the feet, re-drape
Undrape entire back
In time with the music, apply lubricant
Massage with music until session/playlist ends

### 1. The Following Section Concerns the Power of Music and Sound which is One of the Aspects of this Invention

### 1.1 Overview

This is by far one of the most important sections to understand, fully understand. This section helps you appreciate how music and sound affect the body. More importantly, how music and sound influence the minds autonomic response that triggers feeling and emotion. Music is the key element that makes this system what it is. Once all of the components in this system are established, music is the driving force that makes the experience come together.

### 1.2 Music Can Control

Since the dawn of human existence, rhythm and tempo pathways that make up the blueprint for music have been instilled into us. As infants, lullabies are softly spoken into our minds by our elders, making us feel safe, relaxed and providing a sense of warmth. As we grow, lullabies are replaced with nursery rhymes and simple, easy to follow songs. Some have different lyrics but the same rhythm and tempo. Songs like “Twinkle Twinkle Little Star” and the “Alphabet Song”. The way we hear or listen to music has the power to drastically and immediately affect our mood, altering cognitive thought and reasoning. Music shifts our emotions and spirits simply by changing chords, rhythms and tempos. In short, music has the ability to transform our state of mind almost instantaneously. Music can regulate and control levels of anxiety as well as assist with stress related disorders. (See Listening, The Ear & Development: The Work of Dr. Alfred A. Tomatis; by Don Cambell.)

### 1.3 Tone Depth

The combined musical tones and notes that make up songs have the ability to heal, release, relax, and rejuvenate. It can bring people together, separate us, and assist in maintaining our individual status all through doing one primary thing, syncing our heart rhythms and brain waves into unison. (See Clayton, Sager, and Will: In Time with Music/Section 4.3/Stanford University.) Listening integrates sensations and perceptions. (See Listening, supra.) Music has been proven to reduce stress and anxiety.

### 1.4 Music Causes Reaction

When we listen to music our bodies become energized. Adrenal glands release in stages that flow with the music. One may get a sudden urge to dance or get up and move when one hears a song one likes. One may begin tapping one's foot or drumming with one's hands. One may break out into an “air guitar” session. One may have a sudden feeling of happiness, enough to make one smile, laugh, or both while listening to music. This is a direct result of what we are listening to and how music affects the mind which in turn, affects the body. Slow music makes one sleepy and lethargic, fast music makes one alert, aggressive and at the ready. Elevator music may make one claustrophobic and angry. The list below is the result from studies regarding music and how it affects emotion. (See Juslin, P. N. (2000); Cue utilization in communication of emotion in music performance: Relating performance to perception. J. Experimental Psychology, 26, 1797-1813.)
happiness=fast, staccato
sadness=slow, legato
anger=fast, legato
fear=slow, staccato
   Staccato: The Italian word staccato (literally detached, plural staccatos or staccati) indicates that notes are sounded in a detached and distinctly separate manner, with silence making up the latter part of the time allocated to each note. The rhythm is not affected. Notes identified as staccato should be played or sung abruptly and short. They are usually notated by a dot over the head of the note when the stem is downward, or by a dot below the head of the note when the stem is upward:

### Example of Music Using Staccato Style:

### Communication Breakdown by: Led Zeppelin

Genres of Music that have Staccato Influences:
Rock
Hard Rock
Reggae
Types of Jazz
R&B
Dixieland
Classical
   Legato: Without breaks between notes; smooth and connected
   Genres of Music that have Legato Influences:
Soft Rock
Ballads
Smooth Jazz
Classical
Heavy Metal
   Early Rock Bands that Emphasize both Staccato and Legato in One Song Quite Often would be:

### Black Sabbath, Jethro Tull, Yes, Pink Floyd, Rush, Allman Brothers Band, Jimi Hendrix

### 1.5 Music for the Masses

Songs were being sung during slavery days that reflected suffering and survival. There were songs sung on the chain gang. Songs are sung during protest, sports, good times and bad. We instinctively sing when were waiting, nervous, scared, happy, at work, during transport, sitting in traffic, getting dressed, tying our shoes, and some of us in the shower. Music is all around us, all the time.

### 1.6 Music Affects Memory

Music is often in our heads when were not even listening. Our brains and memory have numerous open templates for holding sounds and music. Have you ever had a song get into your head and it wouldn't leave? Maybe it's a song you briefly heard on the radio or someone next to you was humming and it transferred to you. Most of the time for us, it's a song we don't like or care for and it stays with us for the day, or longer.

One may think about an old friend, or those that have left our lives, or an old love, or existing one? We have a piece's of music and songs for memories, people and experiences. When we think about those things, it isn't long before music enters our head. It works both ways as well, when we hear a particular piece of music or sound, we immediately think of them, a memory, or an experience.

### 1.7 Examples of Music which Trigger Memory, Emotion, Feeling, and Autonomic Responses

There are dozens of examples of music through life that affect our memory. Here are some examples of music that you might have heard at a wedding or function which trigger memories, emotions, feelings, also resulting in autonomic responses;
The Electric Slide
The Macarena
The Chicken Dance
Everybody Dance Now
Wind Beneath My Wings
Daddy's Little Girl

Music that might generate an autonomic response resulting in “goose bumps” would be;
The Marine Corps Hymn
God Bless America
Our National Anthem
Mozart
Beethoven

### 1.8 Summary

Music affects almost everything we do and what we do affects music. In a sense, music is life and life is music. Contemporary experiments reveal that emotional reactions to music are real, because music produces specific patterns of change in heart rate, blood pressure and other autonomic bodily reactions that are linked to different emotions. (See MuSICA Research Notes Vol. VIII, lss. 1, Winter 2001.url) This system utilizes the inherent qualities of music and sound and intertwines them with massage strokes and movement. As a result, the recipient's mind and body sync with the music, then sync with the massage they are receiving coinciding with the music, resulting in a massage that is in a class by itself. The Lotus system is that class.

### 2. The Following Section Concerns Noise Cancellation which is One Aspect of this Invention

### 2.1 Overview

This section of the system enables one to appreciate why ambient noise cancellation is so important for the recipient and the CMT/LMT during a massage. By fitting the recipient and the CMT/LMT with sanitized, noise cancellation headphones, ambient sounds are removed creating a relaxing environment in their body and mind. The recipient is not distracted by the immediate, outside world which would otherwise affect the quality of the massage and the overall experience. As for the CMT/LMT, being able to concentrate on the music and the massage without distractions helps them embrace the music, thus producing a quality massage like no other.

### 2.2 Get Out of My Head!

Most, if not all spas, salons, and retreats pipe music through the ceiling or worse, through a boom box tucked away in a corner with some candles on it. This also includes, if any music being played at all, chair CMT/LMT's in a corporate setting or a mall, airport, etc. It is ridiculous to play music in an environment that's overwhelmed with ambient sound. The true potential of the music or sounds are not realized or justified by doing this. Any chance to be enveloped by the music and fully relax is not achieved. Even if the recipient is receptive enough at the time of receiving, it is difficult to continuously concentrate on the music and massage at the same time. A gap is created and most lose any sense of being part of what they are listening to during the session. When receiving massage, one should not have to concentrate in order to relax. The recipient only hears bits and pieces of the music from time to time. The music's worth becomes worthless.

### 2.3 Comfort Zone

In the field of massage, music is supposed to be used as a tool to help the recipient relax and feel comfortable. Ambient noise between the music and the recipient has never been recognized or considered to be a hindrance, but it is in so many ways. When the recipients' body and mind react to music, they become more willing to receive on a conscious and subconscious level. If there is a “break” in that relaxation, even a momentary “break” because of ambient noise, the body and mind has to reset itself. This causes subconscious stress on both the recipients' body and mind. The recipient starts thinking about things and then has to make a conscious effort to clear their mind, again. It takes time for the mind to clear, the body to relax and for the recipients' heart rhythms to sync with the brains' energy pulses. A perfect example of this would be just starting to relax as a recipient ten minutes into the massage session and you hear a phone ring through the wall.

When using the system, music becomes more than a comforting tool. It becomes the driving force that turns what's thought to be “just a massage”, into a journey and experience. When the recipient is fitted with an ambient noise cancellation device, only being able to listen to the music and the CMT/LMTs' voice when needed, their state of mind enters a place they rarely have gone before, if ever. It provides a place of total relaxation and unison within themselves, powered by the music and the massage linked as one.

### 2.4 Understanding the Separation of Sounds

Decipher the range and depth of sounds emanating from a rainforest. You'll find it contains a foreground, mid-ground, and background presence of sounds shifting through each other. It is a constant. If you concentrate on one particular sound, the rest is now ambient noise. If the ambient sound becomes louder or more dominant, it becomes more difficult to zero in on what you're listening to. The same happens if there is a sudden burst of noise not affiliated with the one you're concentrating on. Having to concentrate and focus more disconnects you from the initial sound you're listening to. It's even more evident when you're sound is in the fore or mid-ground and you pick up the now dominant sound emanating out of the background. Our mind instinctively picks up the “new” sound and throws us off our focal point.

### 2.5 Examples of the Ambient Noise World Surrounding Massage

Place yourself in a corporate setting providing chair massage. If you've ever done this then it's quite possible you're concentration was thrown off at one time or another due to a file drawer being slammed shut, or a burst of laughter passing through just a few feet away. You momentarily feel jolted, then confused why someone would have no consideration for what you're attempting to achieve, then and a little agitated at them doing this. While you're contemplating what just happened, your focus on the massage was lost. Then it happens again.

Now put yourself in the chair as the recipient. Imagine how they feel. Are you able to relax? Office and cell phones are ringing. People are walking by talking . . . loud while the bells and whistles of fax and copy machines murmur and sputter.

When music is played through a stereo six to eight feet away in a corner, or six feet above you from the ceiling, you lose all the inherent qualities of experiencing the music as a whole. So again, when one is literally separated from the music, they are subjected to a wide variety of ambient sounds which inhibit them from receiving comfortably. Other examples of this are again, phones ringing through the wall, floors creaking, and movement from in and outside of the room. More examples of these ambient sounds are conversations being held outside your room or perhaps the slamming of a door or better still, a toilet flushing.

### 2.6 Making a Difference

To ask the question, “Does the cancellation of ambient noise really make a difference?” Yes, it does. It can completely change the entire experience. This system changes the way massage is perceived, employed and remembered.

### 2.7 Do Not Employ Without It

The recipients' headset volume needs to be at comfortable level not damaging their hearing. Also, the level should be just loud enough to block out ambient noise but low enough to hear the CMT/LMT from a close proximity (speaking softly next to their ear). Communication from time to time is a very important part between practitioner and recipient.
The volume of the CMT/LMTs' headset should be just loud enough to hear the recipient and low enough to hear other important things, such as an emergency. This is one of the reasons why it is so important to know you're music inside and out, enabling you move with it and still be at the ready.
Be extremely communicative with your recipient prior to, at times during, and after the session.
It is vital to keep the recipients headset clean and sanitized (see section 6.0/SAFETY and HYGIENE), Make it known to the client that you practice this before and after every session.
Have the recipient's headset volume pre-adjusted prior to you placing it on their head. As a convenience to the recipient, the headphones provided for them have a volume adjustment on the cord so they can adjust as they see fit. Always follow the same guidelines (Code of Ethics) you learned when preparing a client for a session. Again, exercise a high level of communication, make sure they are comfortable, and above all, be professional.

I have been using this system for over two years with these factors in place and it works wonderfully.

### 2.8 Summary

To sum up this section is easy. Here's how it works. Ambient sound is cancelled out by fitting the recipient and you the CMT/LMT with sanitized, noise cancellation headphones. This removes both of you from the immediate, outside world. Once the recipients' and the LMT/CMTs' heart rate and mind sync to the rhythm and tempo, the recipients body becomes more willing to relax on a conscious and sub-conscious level and the LMT/CMTs' able to properly blend the music into the massage with little or no distractions from the “ambient world”. Appropriate music is played through both headsets at a comfortable level so communication is still achievable if need be. One key factor is the CMT/LMTS' headset is wireless enabling them to move freely around the massage table/chair.

### 3. The Following Section Concerns Sight Cancellation which is One Aspect of this Invention

### 3.1 Overview

This section explains how effective 360 degree sight cancellation is to help one relax during a massage. Tying this in with the previous section, ambient noise cancellation, it's easy to see why they go hand in hand. The thought of being able to relax without having to consciously keep your eyes closed during a massage is relaxing enough. To have it combined with the elimination of ambient noise is even more enticing. Cap it off with a massage intertwined with the music you're listening to?

### 3.2 Visual World

### Example 1

For those who are among the corporate world, the recipient walks the same floor day in and day out. While they talk on the phone, they sub consciously count the color separations in the tight burbur carpet. Chances are they know how many floor and ceiling tiles make up the break room, and there's a good possibility they know how many steps it is from their desk to the bathroom. Why should they be subjected to seeing that floor in a fixed position for an extended period of time when they're trying to relax?

### 3.3 Visual World

### Example 2

Similar situations are present in a clinical setting. There usually is a bit of nervousness (start humming or singing) going to a physician, chiropractor, dentist, OBGYN, etc. . . . The fact is most individuals want to get in and out as quickly as possible. Sure they want to receive the proper treatment as to what ails them but who reading this can't say they haven't counted the ceiling tiles or wondered who picked out the atrocious carpet pattern while waiting? When implementing massage into the clinical environment, sight cancellation is a valuable tool to help the recipient relax.

### 3.4 Visual World

### Example 3

As far as a spa or salon setting is concerned, yes it's nice to have the “foof” once in a while. Soft lighting, candles, walls adorned with admirable artwork or photography to help create a relaxed environment. Yet you are still seeing everything around you during the session. It's the movement of shadows, hearing all ambient sounds, coupled with consciously keeping your eyes closed. All three of these elements can profoundly affect a quality massage.

### 3.5 Quick Summary of Examples

Whether in a massage chair or prone on a table, ambient light is a culprit jeopardizing a relaxing massage. Without using the System as a recipient, feels like looking into a microscope when the head is in a face rest. The peripheral vision is eliminated and the recipient is staring at the floor watching the tango style footwork of the CMT/LMT working on the recipient, hearing everything that's going on while trying to concentrate on the music. It's worse when supine because the peripheral vision is expanded and the same audible distractions just mentioned are more evident.

### 3.6 Don't Believe Everything You See

Some therapists mention that once the session starts the recipient's eyes will be closed anyway, so the recipient will be relaxed. That's not necessarily true. First, one has to try and relax. The recipient just drove to the destination. Red lights, dealing with other drivers on cell phones or texting not watching what there really supposed to be doing. Traffic in general. The recipient is still thinking about work, kids, bills, life. For some recipients, they still have the image of a computer screen etched in their vision from work. One can't just come in, lie down and instantly have it all go away. They require some assistance.

Most clients suffer from eye strain to some degree and welcome the thought of not having to consciously keep their eyes closed. During the moments they're disrobing, they have gone as far as placing the sight inhibitor over their eyes before the CMT/LMT re-enters the room. They want to be swept away from the outside world almost immediately entering my facility and they know this is an effective tool. Some CMT/LMTs' don't even ask the recipient if the lighting is at a comfortable level.

### 3.7 What's Missing?

Other than the decor, there are three key components that aren't quite right in the environment, but the recipient has been trained that this is the norm. Everyone has candles and/or aromatherapy of some sorts, and attempt to have proper lighting with pleasing artwork or decorations to enhance the room. What is lacking is; one, the recipient is detached from the music. Two, the recipient can hear everything between themselves and that music, and three; the recipient is subjected to seeing everything during the session. When these components are separated, they don't seem like much but when they are combined, it creates a false sense of relaxation.

### 3.8 Summary

This section utilizes the ability to cancel out ambient light for the recipient so they do not have to consciously keep their eyes closed during a massage session. Simply by placing a soft, sanitized, terry cloth towel at the bridge of the headrest (prone) or over the recipient's eyes (supine) close to, if not, total 360 degree sight cancellation is achieved. In doing so, the recipient enters a deeper state of relaxation taking the massage experience further into their subconscious. When coupled with the system's ambient noise cancellation technique and the presence of aromatherapy, these three components are the “disks” within the spine so to speak. The vertebrae of course are music and touch.

### 4. The Following Section is a Brief Outline for Using Oils and Blends

### 4.1 Choosing the Right Oil

With so many ailments in modern society and so many oils and blends to choose, a CMT/LMT might find it easy to just take the aroma that they like because it smells nice to them. This is a big mistake. A CMT/LMT could actually be doing the recipient great harm without knowing it causing allergic reactions, dermis reactions, and respiratory reactions. The list is quite extensive as is the list for choosing the proper oils or blends for each specific ailment. It is imperative to know the oils and blends prior to application. This means research and finding what's right or what one wants to specialize in. Some CMT/LMTs' specialize in using oils and blends for one or two very specific ailments. Others offer a variety of ten or more to “cure” what ails you, whatever it may be. This is done for a couple of reasons. One, some like to not get too involved because of the vastness the oil and blends world has to offer and like be unique carrying the “hard to find” stuff. Two, it takes some time to build up an inventory due to the fact that oils and blends of great quantities get quite pricy.

Either way, CMT/LMT should make sure to have questions pertaining to allergic reactions to oils in general on the Client Intake Form and go over the form with them prior to the massage session. For various reasons, some recipients are reluctant to provide information on the intake form but “warm up” to conversation when asked.

Essential oils and blends are making their way into the mainstream of massage and it's always nice to have at least one or two varieties on hand. A CMT/LMT does not have to practice using oils if the CMT/LMT is not comfortable with them.

### 4.2 Very Important Note to Understand

The following list is a guide of what oils and blends pair up with certain ailments. Let it be known that this list is only a reference guide to be used for educational purposes only. It is not guaranteed to be accurate nor complete.

### 4.3 List of Suggested Oils for Possible Ailments

This list indicates the possible oils and blends that could help with the specific ailments underlined, in bold face, capitalized and underlined only.

Promote Inner Peace and Happiness
Ylang Ylang, Sandalwood, Geranium, Rose, Orange, Lemon, Frankincense, Neroli, Bergamot, Grapefruit

Promote Self-Confidence
Grapefruit, Orange, Rosemary, Jasmine, Bergamot, Cypress, Bay Laurel

Help Against Insecurity Issues
Frankincense, Sandalwood, Vetiver, Bergamot, Cedarwood, Jasmine

Help to Battle Fatigue, General Burnout and Exhaustion
Sandalwood, Rosemary, Basil, Jasmine, Black Pepper, Clary Sage, Lemon, Peppermint, Vetiver, Bergamot, Ginger

Help Against Anger Issues
Ylang Ylang, Neroli, Rose, Jasmine, Orange, Bergamot, Vetiver

Help to Battle Stress
Rose, Jasmine, Neroli, Bergamot, Vetiver, Ylang Ylang, Clary Sage, Frankincense, Grapefruit, Lavender

### 4.4 Similarities in Oils

As one can see, a lot of the same oils assist with totally different ailments. By choosing one that assists with four or five separate ailments, it can possibly do nothing but good things in those key areas. Also, keep in mind that this is only a small list of what's available out there. There are several other ailments that oils have been known to assist with such as; Panic Attacks, Irritability, Anxiety, Depression, Fear. It is up to you to the CMT/LMT to choose what works best for the recipients.

### 4.5 Important Safety Information

However the CMT/LMT chooses to use the oils, it is advisable to consult a qualified aromatherapy practitioner prior to taking any action. If one is pregnant, has cancer, liver damage, or any other existing medical condition, only use oils under close supervision and guidance of a qualified aromatherapy practitioner. Exercise extreme caution when using oils with children. Only use extremely low dosages and the gentle oils when dealing with children. Be sure to consult a qualified aromatherapy practitioner prior to using oils with children. Do not internally take oils without consulting a qualified aromatherapy practitioner. It is best to perform a skin patch test prior to using any oils that were never used before.

### 5. This Section Deals with “Touch”

### 5.1 Overview

This section of the system requires the most practice because it is the link that ties the music to the recipient. Once the recipient realizes that the music and the massage they're receiving are one, the real journey begins.

### 5.2 Improvise

The core of the System emulates the flow of music and sounds through constant movement and acupressure. This system utilizes all the major strokes of Swedish massage with influences of Amma. The key is learning to use the strokes in unison with the timing of the music. As shown in TABLES 1 and 2, each stroke is specified to coincide with tonal levels on the music scale. There are constant variances of pressure matching the tonal levels. The images shown in the back of this manual provide a visual aid. The strokes are employed together and separately which correlate music and sound as a whole.

TABLE 1

| | | | |
|---|---|---|---|
| Petrissage | Low | Most Distal and Lumbar | Deep |
| | Mid | Mid Back/Mid Extremity | Med to Deep |
| | High | Most Proximal/Cervical | Superficial |
| | | | to Medium |
| Effleurage | Low | Most Distal and Lumbar | Deep |
| | Mid | Mid Back/Mid Extremity | Med to Deep |
| | High | Most Proximal/Cervical | Superficial |
| | | | to Medium |
| Light Eff./Nerve Stroke | Low | Most Distal and Lumbar | Superficial |
| (Great Finishing Stroke) | Mid | Mid Back/Mid Extremity | Superficial |
| | High | Most Proximal/Cervical | Superficial |
| Compression | | | |
| Sustained Pressure | | | |
| Ischemic Pressure | Low | Most Distal and Lumbar | Deep |
| (Trigger Point) | Mid | Mid Back/Mid Extremity | Med to Deep |
| | High | Most Proximal/Cervical | Superficial |
| | | | to Medium |
| Friction | | | |
| Vibration | Low | Most Distal and Lumbar | Deep |
| | Mid | Mid Back/Mid Extremity | Med to Deep |
| | High | Most Proximal/Cervical | Superficial |
| | | | to Medium |

TABLE 2

| | | | |
|---|---|---|---|
| Tapotment | Low | Most Distal and Lumbar | Deep |
| | Mid | Mid Back/Mid Extremity | Med to Deep |
| | High | Most Proximal/Cervical | Medium to Superficial |
| Accupressure | Low | Most Distal and Lumbar | Deep |
| | Mid | Mid Back/Mid Extremity | Med to Deep |
| | High | Most Proximal/Cervical | Medium to Superficial |

It is of vital importance to know and always be aware of Endangerment Sites when massaging. The system follows the same strict guidelines as any other modality, Maintain a proper distance from these fragile regions of the body.

### 5.3 Adapting Pressure Variance and Strokes with Music

The charts provided above are templates to offer guidance. The music creates the massage. It is important to understand that these strokes and movements are not just intended for those specific areas, If they were, every massage one provides would be most vigorous and place a tremendous strain on the body. One would be all over the place trying to do something that can't be done. Remember to keep it simple.

Also, while one is moving with the music, each section of the body one is working on can be broken down into low, mid, and high note “mini-sections”. Don't over exert oneself by trying to massage every note and every beat. Choose specific parts of the music one wishes to accent stroke value, pressure variances, and duration in the area massaging. Allowing the music to move through you while massaging will promote a more fluid and better quality massage.

### 5.4 Do, re, me

By separating into low, mid and high notes that coincide with lumbar, thoracic, and cervical regions the body is now an open canvas to create a sequence. As shown in TABLE 1 and TABLE 2, the same applies for each extremity; proximal to distal, and vice versa depending on how the music is moving along the scale. Listening and separating the notes into a random or set sequence becomes easier with practice. Always adjust pressure with the intensity of the note massaging.

### 5.5 Massaging with the Music Scale and Sustained Notes

The variances in pressure are pre-determined as the stroke progresses. As the tonal levels change, so will your pressure. This direct application is evident when the tonal changes occur. For instance, when beginning a stroke the tonal level drops from an “A” to a “D” minor in 4 counts, the stroke starts at the proximal end of an extremity or in the cervical region of the back. As the stroke progresses with the tonal change, the pressure goes from superficial, to medium, to deep by the end of the stroke. The deep pressure will be sustained as long as the low note holds. It is crucial to know the music and sounds inside and out so one can predetermine the stroke or movement best suited, The same applies for low to high notes. If the tone begins to rise, the CMT/LMT changes the stroke direction and pressure, constantly flowing with the music or sounds. As mentioned in paragraph 5.3, The CMT/LMT does not create the sequence, the music does.

Sustained notes, especially those used in the New Age genre can not only travel from cervical to lumbar, proximal to distal of an extremity, but also be brought across the back or the extremity, perpendicular to the rhythm and tempo pathways and muscle fibers (cervical to lumbar, proximal to distal and vice versa).

One very important item to follow is if the tone rises, attempt to stroke towards the heart. If it lowers, attempt to stroke away from the heart while keeping the variance of pressure with the intensity of the note massaging to. Keep in mind that this pertains to the extremities, the back, and the “mini sections” of those areas.

### 5.6 Transitions Involving Right and Left Speakers

### Mid-Sagittal Planes (FIG. 2)

Recorded music is sometimes split into the right and left speakers giving the listener a heightened sense of transference. It can cause the mind and body to separate into right and left sides, or blend back and forth through the speakers providing a feeling of movement within the body. If a sound or instrument emanates in one specific side (speaker), the CMT/LMT flows to that side. Whether a sustained note/s, or quick transitions from one side to the other, the CMT/LMT moves with the sound/s and or instrument/s to further enhance the overall feeling of movement within the body.

For instance, if prominent sounds emanate in the right speaker, the right side of the back or lateral side of the extremity is massaged. It is crucial for the CMT/LMT to know when transference occurs from one speaker to the other before it happens. It is vital to maintain optimum pressure and constant flow during that transition. If employed correctly, the recipient and the CMT/LMT literally enter a trance like state. The CMT/LMT and the recipient become one with the music. NOTE: the CMT/LMT must always adjust massage pressure with the intensity of the sustained note/s and or sounds transferring.

### 5.7 Matching Massage Speed with Rhythm and Tempo

Also, the rhythm and tempo determine the speed of the massage, keeping the variances of pressure in sync. If the recipient wishes to “wake up”, a faster more upbeat choice of music is best suited. If a more relaxing and de-stressing massage is requested, something with a much slower tempo and rhythm is recommended. Again, adjust pressure with the intensity of the note massaging to.

### 5.8 Summary

To sum up this section would be to state that the massage strokes and movements are literally woven into the patterns along the music scale being played, constantly adjusting pressure variance with note intensity. The list below contains the components that must be understood and met in order to employ this section of the system properly:
1. Be able to differentiate, separate, and unify musical notes coinciding with an effective massage stroke or movement.
2. Move with the music as opposed to following it when massaging.
3. Know your choice of music well enough that you can predetermine a stroke or movement, including variances in pressure, to an upcoming change in rhythm, tempo, or scale movement.
4. Adapt yourself to flow with the music.
5. Understand the strokes and movements of massage used in this system to coincide with the music and sound you and your recipient are listening to.
6. Hone your ability to perform these strokes through practice.
7. Understand beats per minute (BPM), rhythm cycles and tempo changes.
8. Basic understanding of how music affects the human body and mind.
9. Adjust pressure with the intensity of the note massaging to.

### 6. This Section Deals with Safety and Hygiene Considerations

### 6.1 Overview

This section covers an aspect of the System, safety and hygiene. The parameters learned by a CMT/LMT in school regarding these two items are taken very seriously in this system and should be implemented into everyday practice.

### 6.2 Suggestions for Safety

There are key sections in the System that require extra attention when it comes to safety. Especially those pertaining to both recipient and CMT/LMT traffic in the receiving area. They are as follows:
When laying out the cord/s from audio output to table or chair, be sure to tape it to the floor. This ensures that neither the recipient nor the Therapist will trip over it.
Prior to taping down cord/s, be sure to leave enough line to get from floor to table/chair, This provides enough line left over for the recipient to self adjust volume located on the cord as they see fit once wearing the headset.
This includes any cords running to an outlet that is some distance away from your station/environment. It is vital that all walkways to and from the area are kept clear and free of obstacles.
If a CMT/LMT chooses to have an environment with cords running to outlets, it's best to have and entry side and an exit side. This keeps recipients from coming in from both sides. It promotes organization and order. Order is the operative slogan when it comes to safety.
Always be aware of the surroundings when setting up the station/environment. Be sure to set up systematically. Provide enough space so one can move freely with no obstructions.
Provide enough room in one's space so the recipient can get on/off the table and in/out of the massage chair with no obstructions.
Make sure all audio devices are charged (MP3), plugged in (CD player, laptop, wireless headphone receiver), and ready to go prior to starting. Make sure wireless headset has fresh batteries and always carry spares. Order is the operative slogan.
After setting up, preset volumes on both the recipients and the CMT/LMT's headset. This ensures that no damage will occur to hearing.
Be sure to ask recipient if they wear a hearing aid or if they have difficulty hearing in general. This provides the information needed to adjust the recipient's headset volume accordingly.
Again, always check headset volume prior to starting.
For recipients that have never received before in either a chair or on a table, follow the guidelines taught in school, and then apply what's in this section.
Be sure to sanitize the recipient's headset before and after every session.
Be sure to sanitize the CMT/LMT's table/chair before and after every session.
Always change sheets between table sessions, sanitize table, and re-fit with new sheets after sanitizer dries. Allow enough time in between sessions to do so.
If providing chair massage, make sure all adjustments are secure and locked prior to recipient getting on chair.
If providing chair massage, once recipient is in chair, make proper adjustments so they are comfortable, then ask, “Are you comfortable? If there are any fine adjustments you could do to the chair to make you more comfortable, what would it be?”
When using a chair or table, make sure they are stable enough and all adjustments are locked and secure.
If providing chair massage, a suggestion of how to get on the chair could be as follows: Ask if they've ever received chair massage before. If they haven't, physically show them how to get on the chair. Suggest that it's best to keep their knees (showing them with using your knees) at least one inch from the front of the pad so they do “over ride” the chair's normal position. Ask them to keep their torso in an upright position (showing them), until you ask for them to lean forward and place their head in the headrest (again, showing them).
If using a massage table to provide, ask them if they've ever received massage on a massage table before, If they haven't, show them. Make adjustments with bolsters and headrest (when prone) after they are on table.
Whether one provides massage on a chair or table, make sure to place audio headset on their heads after they are on/in and then ask if it is a comfortable fit. Make fine adjustments if need be.
Be sure to suggest to the recipient just before massage begins that they practice a relaxed breathing cycle.
If providing table massage and the recipient starts supine, place sight inhibitor over their eyes just at the bridge of their nose after all adjustments are made and after audio headset is on their head,
If providing table massage and the recipient starts prone, be sure to have sight inhibitor already in the headrest and guide their head into the headrest making sure the sight inhibitor settles just on the bridge of their nose. Place audio headset onto the recipients head. Ask if it is a comfortable fit and making fine adjustments if need be.
The same goes for providing chair massage, make sure the sight inhibitor is already in headrest and guide their head into it making sure it settles just on the bridge of their nose. Ask if it is a comfortable fit. Make fine adjustments if need be. Place audio headset onto the recipients head. Again, asking if it is a comfortable fit and making fine adjustments if need be.

### 6.3 Suggestions of Hygiene

NEVER USE THE SAME DISPOSABLE HEADREST COVER TWICE!
Wash sheets after every use.
Keep finger nails neatly trimmed, short and clean.
Wash hands before and after every massage for a minimum of two minutes.
If one uses hand sanitizer, be sure to wash hands periodically throughout the day as well.
Keep hair neatly cut and for men, keep any facial hair shaved and/or trimmed.

### Helpful Tips and Suggestions

Keep a running stock of inventory at a plentiful state such as disposable headrests, batteries for headsets, sheets, hand sanitizer, lotions gels, and oils.
Look for sales on the supplies used,
For those selling products, be sure to keep display cases clean, and uncluttered.
If one uses one's own vehicle for one's business, be sure to always keep it clean a free of trash. Wash the vehicle often. The vehicle is a first impression in the public eye, especially when arriving at a sight, restaurant, etc. . . . (if one has a logo is on the vehicle).
Recycle all paper, plastic, cardboard, and glass waste (Disposable headrest covers are considered paper products).

### 7. In General

The information given throughout this manual covered many areas. Each of the sections provided the essential tools to understand how the system works and what the overall intent is as a new modality. Each element has been broken down to a simplified and easy to understand format using examples, association, and imagery. It's easy to see how each section works independently and how combined, create a new and undiscovered technique in providing a high quality and memorable massage. One can apply this system to full body or corporate chair massage. With this information, every massage given using the system has the means to be unique in its own right. One is able to connect with the recipient in a way that has never been executed before. Enhancing four of the five known senses gives the CMT/LMT that right. The CMT/LMT has the tools to better predict the outcome of every massage using the system.

### 8. The Following is a Discussion of Various Specific Applications of this invention

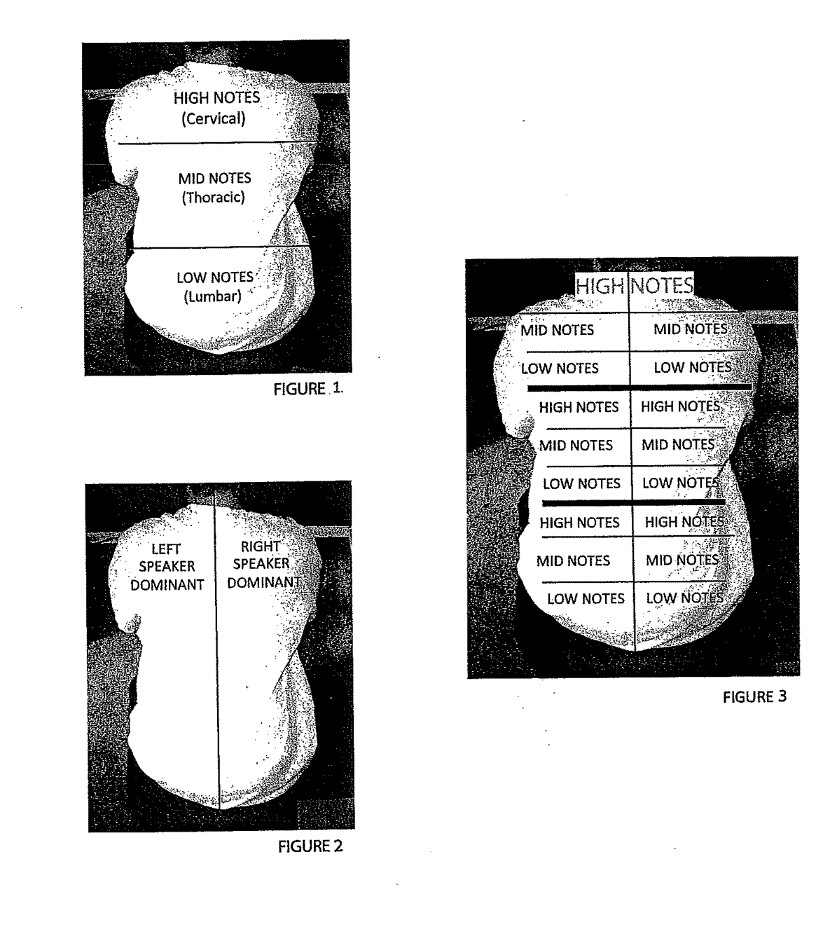

FIG. 1 shows how the low, mid and high notes coincide with lumbar, thoracic, and cervical.

These three sections are intended for broad strokes and movements that span from lumbar to cervical (low to high note), and cervical to lumbar (high to low note) in one stroke or movement.

It can be used in one quick stroke that coincides with a quick ascend or descend upon the music scale (less than 4 counts). Or, a slower, more drawn out progression ascending or descending the music scale (more than 4 counts).

It is vital to maintain the proper pressure during this transition. See TABLE 1.

FIG. 2 shows how the right and left speakers coincide with the midagittal plane (right and left sides).

It is of great importance to know the selection of music well enough to predetermine when either side will be dominant. Thus, providing bodywork to that side.

This usually occurs during a quick transition between right and left (speakers) sides that will determine the overall stroke or movement. Remember to flow with the transition.

Always adjust massage pressure with the intensity of the note transitioning.

FIG. 3 shows how the back is broken down into smaller sections of low, mid and high notes to provide massage with music in a specific area.

As shown, the portions are equally separated in the lumbar, thoracic and cervical regions that also coincide with the mid-sagittal plane (right and left sides).

These smaller sections are portioned out to provide bodywork in specific areas while still being able to utilize this system massaging with the music.

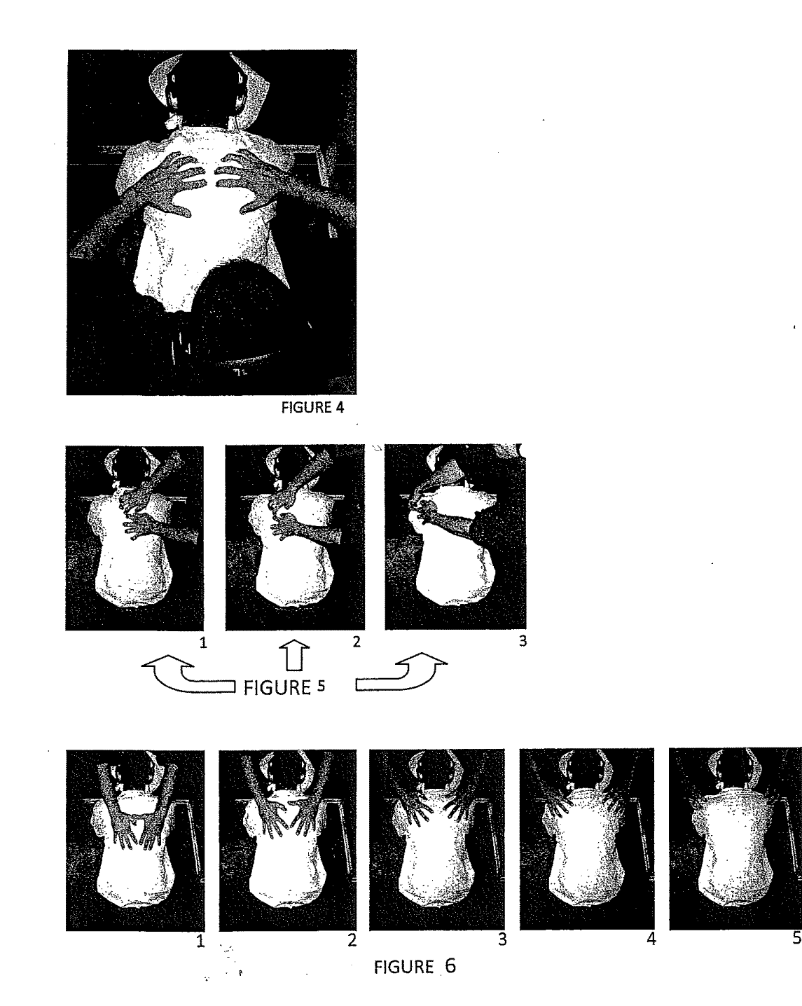

FIG. 4 shows a specific movement/stroke which is shown in the final stage of the movement. The movement is similar to a butterfly. It begins in the lumbar region, just lateral to the vertebrae with fingers together in a vertical set. As the stroke progresses towards the cervical region, the fingers start to open the butterflies' wings outward moving along the vertebral borders of the scapulas, just lateral of the vertebrae and medial to the vertebral borders (in between the spine and the shoulder blades).

When executing this stroke, the variance of pressure increases as the stroke progresses upward. If executed correctly, it gives the recipient a feeling of completion during an ascent along the music scale. A great finishing move to this stroke is just as your fingers pass the superior angle, roll your fingers on end and follow along the superiod angle bringing all five fingers towards the acromion, partially closing the “wings” and begin a nerve stroke down the arms.

Example when to use the Butterfly: rumbling symbols over a 4 plus count period found in the classical genre.

This stroke shown in FIG. 5 is designed for a right or left audio dominant situation. As shown in FIG. 5 (1) you begin just medial to the vertebral border with finger tips on end applying medium pressure in a fan position. As the stroke progresses, travel over the scapula (2) sustaining pressure, and as shown in (3), the hand most superior goes first with the inferior hand following behind. This can be used for sustained notes, rolling symbols or other various sounds. Great finishing move is to again, go into a nerve stroke down the arm.

FIG. 6 illustrates a stroke which begins in the lower thoracic region (T9 or T10 area) with the fingers in a semi open fan position. Apply medium pressure throughout stroke, opening to a full fan, and as you near the acromions (4), turn fingers on end (5) completing the movement with a nerve stroke down the arms and follow through to the most point on the philanges.

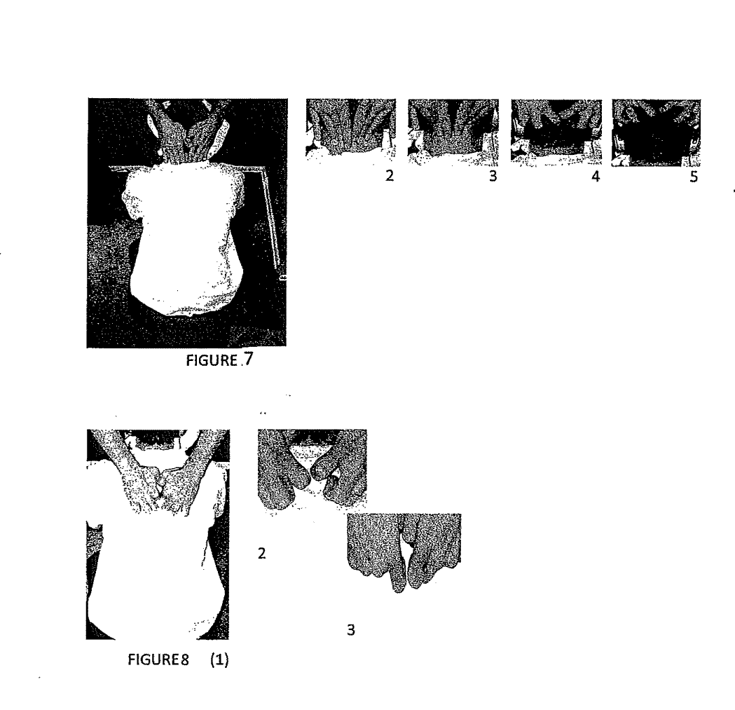

FIG. 7 is a basic stroke used in both table and corporate chair massage. Begin this stroke with fingers in a closed set position at C5 (1) and using index fingers as a guide on the spine (2) (superficial pressure with index fingers), apply lateral to the spine and proceed up to the occiput (3), Then, using finger tips (4) create a finishing stroke up to the top of the cranium applying superficial to medium pressure (5). A time to use this stroke is either at the end of a song or when there is a quick ascent on the music scale (less than 3 counts).

The move shown in FIG. 8 mimics the motion of Shiatstu spheres rolling down the recipients' back, or up. Using your “middle” knuckles, follow one after the other to the third (ring) finger starting with your index “middle” knuckle. This move/stroke is great for a constant or steady beat. You can vary the pressure as you see fit. It can be applied just lateral to the vertebrae, in the upper “trap” region. In the rhomboids region.

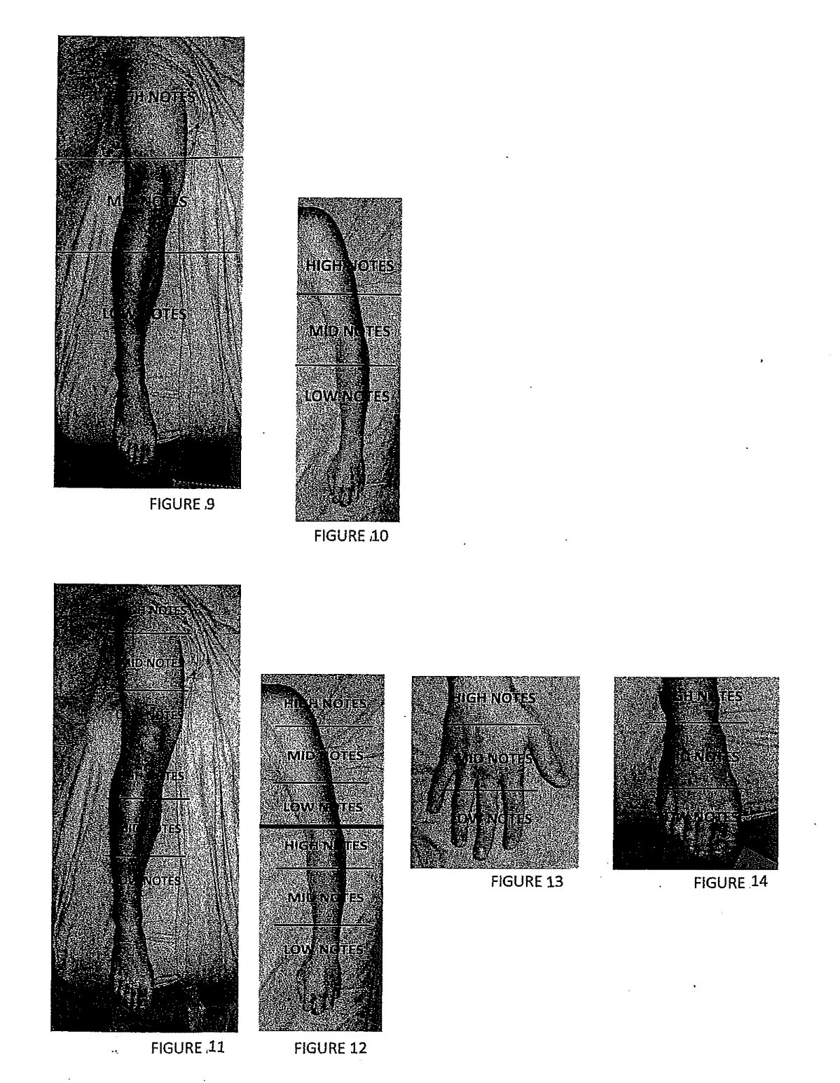

As shown here in FIG. 9, each extremity can be separated into “High, Mid and Low” note sections for broad strokes and movements. Be mindful of your pressure when in the patella region (supine) and the popiteal region (prone). Your best bet is to just “glide” around it, staying in time with the music and stroke.

In FIG. 10 it is shown as it would pertain to an upper extremity. Whether prone or supine, be mindful of endangerment sites. Especially in the brachial (elbow) regions.

In FIGS. 11-14 it is shown how the High, Mid and Low “mini sections” of the upper and lower extremities are broken down to. It is simple to apply but again, be very aware of endangerment sites.

### 9. Summary

The technique of this invention not only removes the massage recipient from their immediate environment assisting in overall relaxation, but it enhances the massage experience in a way that has never been approached before. By combining the components mentioned in the description, it accomplishes several positive results at once for the massage recipient.

Implementing 360 degree sight cancellation relaxes the recipients' motor cortex and triggers their mind to reset the body back into a natural state of homeostasis. The massage recipient does not have to consciously keep their eyes closed enabling them to relax into a deeper state, heightening their subconscious mind. It also promotes cell and tissue repair along with cell reproduction. There are a host of other benefits as well.

Using aromatherapy promotes a wealth of positive results helping the massage recipient to cope with daily mental and physical conflicts such as stress, anxiety and other physiological issues that might otherwise hinder their normal state of mind.

Integrating ambient noise reduction eliminates sounds that are not related to the massage that could otherwise jeopardize the quality of the massage and the outcome originally intended, which is to help heal and relax the recipient. By doing so, it enables the recipient to completely relax and concentrate on nothing, keeping the mind clear of distractions.

The practitioner is fitted with remote/wireless noise reduction headphones enabling them to not only move freely around the table/chair, but more importantly, providing them with the freedom to feel and flow with the music and/or sounds. The volume setting for both is at a comfortable level, blocking out ambient noise but low enough so they can communicate for various reasons if need be.

Massage and music hold many of the same holistic properties, too many to mention in fact. That is why it is so critical for the recipient to be fitted with sanitized headphones, It enables them to capture the inherent qualities of music and sound that under normal circumstances would not be heard from some distance away. It is only natural for these two to pair up. Music has always been used as a background element with massage to assist in relaxation. This system harnesses music's true potential.

Implementing music and sound through ambient noise reduction headphones stimulates the neuropathic energy pulses in the recipient's mind immediately affecting cognitive thought and reasoning, as well as their emotional and physiological state. It also creates a bridge for their heart rhythm to match with their brain synapse output. In addition, implementing music and sound directly into the massage sequence and vice versa, it creates a direct link to the massage recipients' sympathetic, parasympathetic and autonomic nervous systems through stimulation and/or sedation caused by the notes, tones, rhythm and tempo patterns, scale progression and breakdowns, sustained notes and chords as well as sporadic sounds.

Combining touch and massage using the grid, it enables the massage practitioner to move with music and sound along the body and its extremities. The grid is plotted out in such a way that the basic notes of music and sound are directly applied to the body and its extremities through touch and massage. Notes that ascend the music scale, the strokes and movement of massage travel towards the heart (proximal). Note and tones that descend the music scale the strokes and movement of massage travel away from the heart (distal). Pressure variance solely depends which notes and tone intensity they choose to flow with. Normally, the higher the notes and tones are on the music scale, the softer and more superficial the massaged touch is to the recipient. The lower the notes and tones are on the music scale, medium to deep pressure massage is applied to the recipient.

This does not mean that it has to be followed in this exact way. A higher note may project an intense tone, thus paving the way to provide more pressure and varied stroke speed. On the same token, a low note such as a D may have a very weak tone by being placed in the mid to background range of the recording. If the practitioner chooses to flow with that note, the pressure and stroke speed may be lighter by comparison. Also, most massage music is recorded in two or more channels constantly transferring between right and left speakers. Using the grid, it enables the practitioner to move from right to left and vice versa traveling across the mid-sagittal plane, It is up to the practitioner to choose which notes, tones, rhythms and tempos to flow with to better predict the desired outcome of the massage session.

Simply by choosing a tempo, the practitioner has the ability to either sedate or stimulate the recipient. Faster tempos stimulate the sympathetic and autonomic nervous systems waking up the recipient. This can be applied for corporate chair massage and/or sports massage prior to an event.

Or, by choosing a slower, more relaxing tempo, it stimulates the parasympathetic and autonomic nervous systems producing a flushed state of mind and body. This can be integrated into the spa and clinical fields. In both cases, there are numerous benefits.

What is claimed is:

1. A music enhanced massage system comprising a first set of headphones to be worn by a recipient who will be massaged, a second set of headphones to be worn by the massage practitioner, and a source of music simultaneously inputting the identical sound of the music into said first set of headphones and said second set of headphones.

2. A music enhanced massage method comprising mounting a first set of headphones on a recipient to be massaged, mounting a second set of headphones on the massage practitioner, simultaneously directing the same music into both of the sets of headphones, and the massage practitioner massaging the recipient in accordance with the sound of the music.
